(19) United States
(12) Patent Application Publication
(10) Pub. No.: US 2011/0241993 A1
(43) Pub. Date: Oct. 6, 2011

(54) Computer mouse with display

(76) Inventor: Jin Biao Shih, Taipei (TW)

(21) Appl. No.: 12/752,156

(22) Filed: Apr. 1, 2010

(51) Int. Cl. G06F 3/033; G06F 13/20

(52) U.S. Cl. 345/163; 710/313

(57) ABSTRACT

A computer mouse includes an image display unit comprising an image processing unit, a top LCD, a work memory, and first, second, and third image buttons on top, all being electrically connected together; a control unit comprising a microprocessor, an optical sensor, left and right buttons, and a scroll wheel, all being electrically connected together; and an interface unit comprising a USB hub and a USB control electrically connected together. The second image button controls on and off of the image display unit. The USB hub is electrically connected to the image processing unit and the microprocessor respectively. The USB control is electrically connected a USB connector at one end of mouse cord. The first image button is operable to store an image in the work memory. The third image button is operable to transfer an image stored in the work memory to the display.

### BACKGROUND OF THE INVENTION

1. Field of Invention

The invention relates to computer input devices and more particularly to a computer mouse having a display (e.g., LCD) on rear top surface.

2. Description of Related Art

Mouse is a computer input device that is used by moving it around on your desk and pressing one or more buttons. Moving the mouse moves a pointer on the screen. Graphical user interfaces such as Microsoft Windows are built around the mouse. Above function of a computer mouse has not been expanded since its invention in 1970s.

It is thus desirable to provide a novel computer mouse having a display and associated memory and processing unit for storing, processing, and displaying one or more images on the display.

### SUMMARY OF THE INVENTION

It is therefore one object of the invention to provide a computer mouse comprising an image display unit comprising an image processing unit, an LCD on a top surface of the computer mouse, a work memory, and first, second, and third image buttons on the top surface of the computer mouse, all being electrically connected together via the image processing unit; a control unit comprising a microprocessor, an optical sensor, left and right buttons on the top surface of the computer mouse, and a scroll wheel disposed between the left and right buttons, all being electrically connected together via the microprocessor; and an interface unit comprising a USB hub and a USB control electrically connected to the USB hub, wherein the second image button is operable to control on and off of the image display unit; wherein the USB hub is electrically connected to the image processing unit and the microprocessor respectively; wherein the USB control is electrically connected a USB connector at one end of a cord of the computer mouse; wherein the first image button is operable to store an image shown on the display in the work memory after being processed by the image processing unit; and wherein the third image button is operable to transfer an image stored in the work memory to the display after being processed by the image processing unit.

The above and other objects, features and advantages of the invention will become apparent from the following detailed description taken with the accompanying drawings.

### BRIEF DESCRIPTION OF THE DRAWINGS

FIG. 1 is a block diagram of a computer mouse according to the invention;

FIG. 2 is a detailed block diagram of FIG. 1;

FIG. 3 is a block diagram showing a connection between a USB connector at one end of the cord of the mouse and the USB control;

FIG. 4 is an environmental view showing a connection of the mouse to a computer; and

FIG. 5 is a perspective view of the mouse with an image shown on its display.

### DETAILED DESCRIPTION OF THE INVENTION

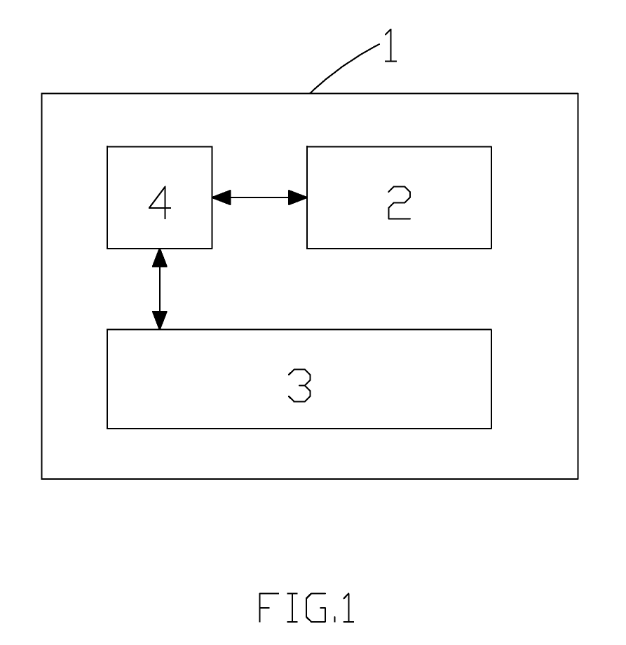

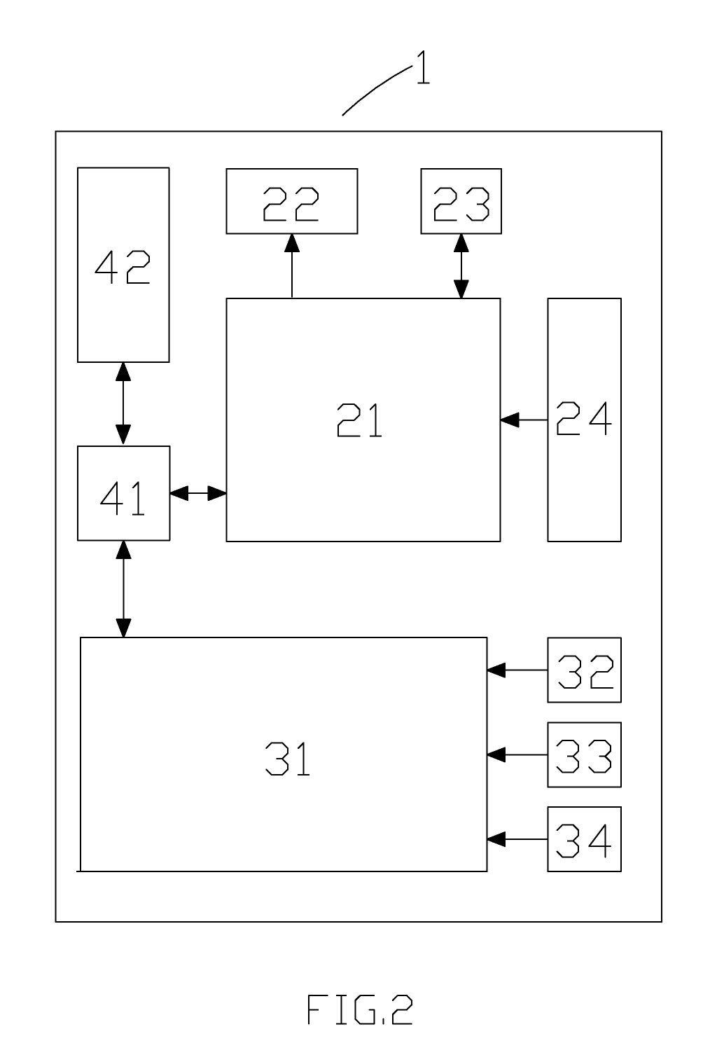

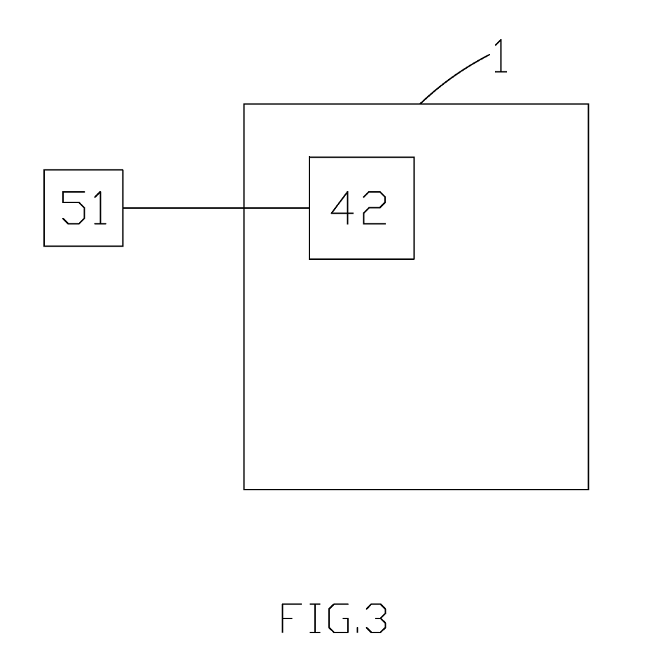

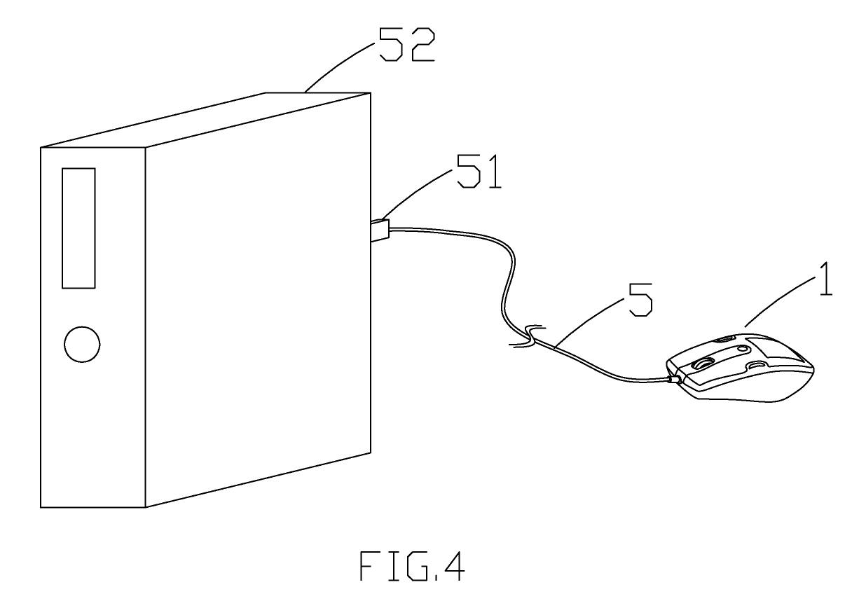

Referring to FIGS. 1 to 5, a computer mouse 1 (e.g., optical mouse) in accordance with the invention comprises an image display unit 2, a control unit 3, and an interface unit 4 all being electrically connected together via the interface unit 4. Each component will be discussed in detail below.

The image display unit 2 comprises an image processing unit 21, a liquid crystal display (LCD) 22 on a rear portion of a top surface of the mouse 1, a work memory 23, and three image buttons 24 on center and intermediate portions of both sides of the top surface of the mouse 1 respectively, all being electrically connected together via the image processing unit 21.

The control unit 3 comprises a microprocessor 31, an optical sensor 32, left and right buttons 33 on a front portion of the top surface of the mouse 1, and a scroll wheel 34 located between the left and right buttons 33, all being electrically connected together via the microprocessor 31.

The interface unit 4 comprises a USB (Universal Serial Bus) hub 41 and a USB control 42 being electrically connected together. The USB hub 41 is electrically connected to the image processing unit 21. The USB 41 is also electrically connected to the microprocessor 31. The USB control 42 is electrically connected a USB connector 51 at one end of a cord 5 of the mouse 1. The USB connector 51 is adapted to plug in a USB port on a computer 52.

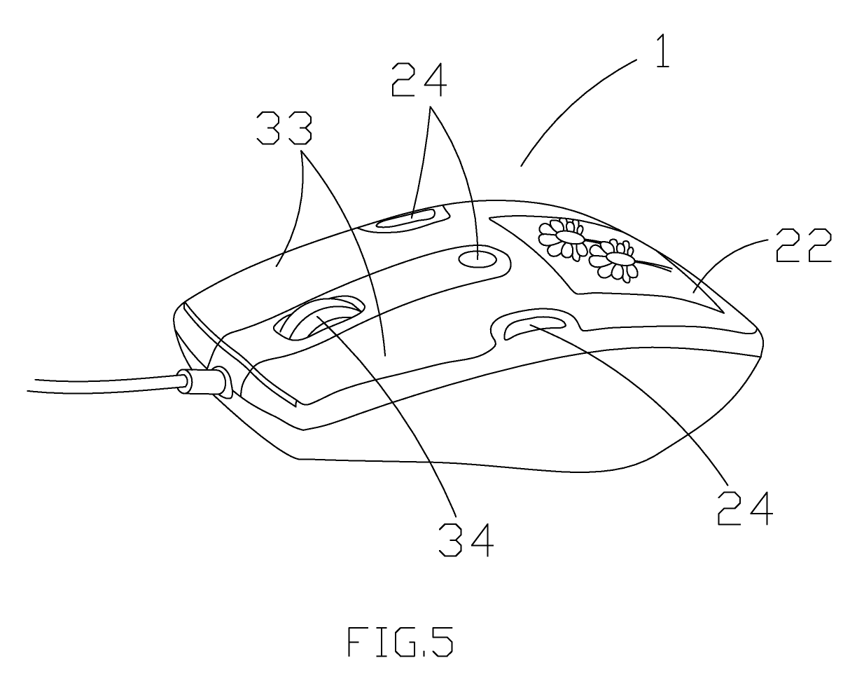

After connecting the mouse 1 to the computer 52 and turning on the computer 52 (see FIG. 5), a user may use the mouse 1 to operate the computer 2. What shown on the screen of the computer monitor (not shown) will be shown on the display 22 by pressing the middle one of the image buttons 24.

Moreover, the user may press, for example, the left image button 24 to store the image shown on the display 22 in the work memory 23 after being processed by the image processing unit 21. A next pressing of the same image button 24 will store another image shown on the display 22 in the work memory 23 sequentially after being processed by the image processing unit 21.

In addition, the user may press the right image button 24 to transfer an image stored in the work memory 23 to the display 22 for display after being processed by the image processing unit 21. A next pressing of the right image button 24 will display a next image stored in the work memory 23 to the display 22 for display after being processed by the image processing unit 21 in a round robin manner.

While the invention herein disclosed has been described by means of specific embodiments, numerous modifications and variations could be made thereto by those skilled in the art without departing from the scope and spirit of the invention set forth in the claims.

What is claimed is:

1. A computer mouse comprising:
an image display unit comprising an image processing unit, a liquid crystal display (LCD) on a top surface of the computer mouse, a work memory, and first, second, and third image buttons on the top surface of the computer mouse, all being electrically connected together via the image processing unit;
a control unit comprising a microprocessor, an optical sensor, left and right buttons on the top surface of the computer mouse, and a scroll wheel disposed between the left and right buttons, all being electrically connected together via the microprocessor; and
an interface unit comprising a USB (Universal Serial Bus) hub and a USB control electrically connected to the USB hub,
wherein the second image button is operable to control on and off of the image display unit;
wherein the USB hub is electrically connected to the image processing unit and the microprocessor respectively;
wherein the USB control is electrically connected a USB connector at one end of a cord of the computer mouse;
wherein the first image button is operable to store an image shown on the display in the work memory after being processed by the image processing unit; and
wherein the third image button is operable to transfer an image stored in the work memory to the display after being processed by the image processing unit.
